(19) United States
(12) Patent Application Publication
(10) Pub. No.: US 2024/0424367 A1
(43) Pub. Date: Dec. 26, 2024

(54) Customizable High-Impact Thermoplastic Grip and Method for Fabricating the Same for Sports Handles

(71) Applicant: EDWARD RAYMOND SANCHEZ, JR., NORTH HOLLYWOOD, CA (US)

(72) Inventor: EDWARD RAYMOND SANCHEZ, JR., NORTH HOLLYWOOD, CA (US)

(21) Appl. No.: 18/212,855

(22) Filed: Jun. 22, 2023

(51) Int. Cl. A63B 60/12; A63B 60/08; A63B 60/14; B29C 51/00; B29C 53/04

(52) U.S. Cl. CPC A63B 60/12; A63B 60/08; A63B 60/14; B29C 51/002; B29C 53/04; A63B 60/54; A63B 2102/18; A63B 2208/12; A63B 2209/00; B29K 2023/083; B29K 2075/00; B29L 2031/52

(57) ABSTRACT

The present invention relates to a customizable grip for sports equipment handles made of a blend of ethylene vinyl acetate (EVA) and thermoplastic polyurethane (TPU). The grip is designed to be heated and imprinted with the user's thumb and fingerprints to provide a personalized grip guide. The EVA/TPU blend absorbs, attenuates, and dissipates shock from high impact forces encountered during the sport. The grip can be used in various sports, including but not limited to baseball, hockey, tennis, golf, and cricket. Furthermore, the impressions can be reset by reheating the grip, allowing for ongoing customization.

### FIELD OF INVENTION

The present invention relates generally to the field of sporting equipment, specifically to a grip for handles used in various sports, such as baseball, hockey, tennis, golf, and cricket. The invention is a swing training aid grip for a baseball bat handle that absorbs, attenuates, and dissipates shock forces while providing a personalized swing guide through moldable fingerprint impressions.

### BACKGROUND

The art of swinging a bat or racket in various sports has been a subject of much interest and development. Skilled execution of this movement requires the player to grip the bat or racket appropriately, keeping the bat or racket close to the body and swinging it in the correct plane. This is a particularly challenging skill for beginners, including children and adolescents, to master. Incorrect or inefficient grip can lead to problems such as insufficient power in the swing, lack of control over the bat or racket, and even physical injury due to undue strain on the wrist and elbow.

Various devices have been proposed to aid in learning and practicing the correct grip and swing. Many of these involve specially designed grips intended to promote the right hand and finger positioning on the bat. However, these conventional devices often fall short in several ways. They typically adopt a “one-size-fits-all” approach, neglecting the individual differences in hand size, finger length, and grip strength among different users. They also frequently fail to offer an adequate level of shock absorption, leaving users vulnerable to the high impact forces generated when the bat or racket makes contact with the ball. These impacts can result in discomfort or injury, particularly in conditions like “tennis elbow”.

Furthermore, existing training aids often do not offer the flexibility of use across different sports. Each sport often has its own unique grip design, rendering the training aids suitable for one sport but not another. This limitation impedes the widespread adoption of such training aids.

In addition, manufacturing these training aids can be complex and costly, involving expensive materials or intricate fabrication processes. The materials used for these grips also often lack the necessary durability and resilience, causing them to wear out quickly and require frequent replacement.

There is, therefore, a need in the art for a grip for sports equipment handles that addresses these issues. Such a grip should be customizable to individual users for effective training and comfort, provide sufficient shock absorption to prevent injury, be versatile enough to be used in various sports, and be made of a durable, cost-effective material that withstands high impact forces and frequent use.

It is within this context that the present invention is provided.

### SUMMARY

The present invention aims to fulfill the aforementioned needs by providing a customizable and adaptable grip for sports equipment handles that absorbs, attenuates, and dissipates shock forces while aiding in proper swing technique.

The grip is designed to take moldable impressions of a user's hand for a personalized and effective swing guide, and is fabricated from a unique blend of ethylene vinyl acetate and thermoplastic polyurethane. This blend has the ability to absorb, attenuate, and dissipate shock forces, thus ensuring comfort and safety for the user.

Additionally, the grip can be easily customized and re-customized through a simple “heat and press” method, allowing for continual adjustments as the user's grip improves or changes. Its application extends beyond baseball, being useful for any sport requiring a handle. Finally, the manufacturing process is simple and uses cost-effective materials, making the grip an affordable and durable solution.

In one aspect, the invention comprises a grip for sports equipment handles, fabricated from a high impact thermoplastic polymer blend. The blend contains ethylene vinyl acetate (EVA) and thermoplastic polyurethane (TPU). The blend may ideally have a composition of 60% EVA and 40% TPU, providing the greatest balance between impressionability and shock absorption.

In another aspect, the invention presents a method for manufacturing the grip. The method includes heating the EVA/TPU blend to over 100 degrees Celsius, rolling it onto the handle of the sports equipment, and impressing the user's thumb and fingerprints into the grip while it's malleable. The grip is then cooled, for example under cold water, for about 30 seconds to permanently set the impressions.

In yet another aspect, the grip is designed to be reusable and adjustable. If the impressions are not correctly positioned, the grip can be reheated to return it to its original shape, allowing for new impressions to be made.

The present invention thus provides a versatile, adaptable, and effective training aid for beginners and experienced athletes alike. It offers an efficient, user-friendly solution to common problems in sports equipment handles, making it an advancement over traditional sports grip technologies.

### BRIEF DESCRIPTION OF THE DRAWINGS

Various embodiments of the invention are disclosed in the following detailed description and accompanying drawings.

FIG. 1 is a side view of the custom fit grip rolled up, comprised of an EVA/TPU blend.

FIG. 2 depicts the grip halfway rolled up a baseball bat handle, showing how the grip is applied to the sports equipment.

FIG. 3 illustrates the grip completely rolled up a baseball bat handle, with the potential for excess plastic to be cut off.

FIG. 4 shows the grip completely rolled up the baseball bat handle with a model hand being used to leave impressions on the grip.

FIG. 5 depicts the grip rolled up on the bat handle with the custom hand model removed, showing the guide impressions left on the grip.

Common reference numerals are used throughout the figures and the detailed description to indicate like elements. One skilled in the art will readily recognize that the above figures are examples and that other architectures, modes of operation, orders of operation, and elements/functions can be provided and implemented without departing from the characteristics and features of the invention, as set forth in the claims.

### DETAILED DESCRIPTION AND PREFERRED EMBODIMENT

The following is a detailed description of exemplary embodiments to illustrate the principles of the invention. The embodiments are provided to illustrate aspects of the invention, but the invention is not limited to any embodiment. The scope of the invention encompasses numerous alternatives, modifications and equivalent; it is limited only by the claims.

Numerous specific details are set forth in the following description in order to provide a thorough understanding of the invention. However, the invention may be practiced according to the claims without some or all of these specific details. For the purpose of clarity, technical material that is known in the technical fields related to the invention has not been described in detail so that the invention is not unnecessarily obscured.

The terminology used herein is for the purpose of describing particular embodiments only and is not intended to be limiting of the invention. As used herein, the term “and/or” includes any combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

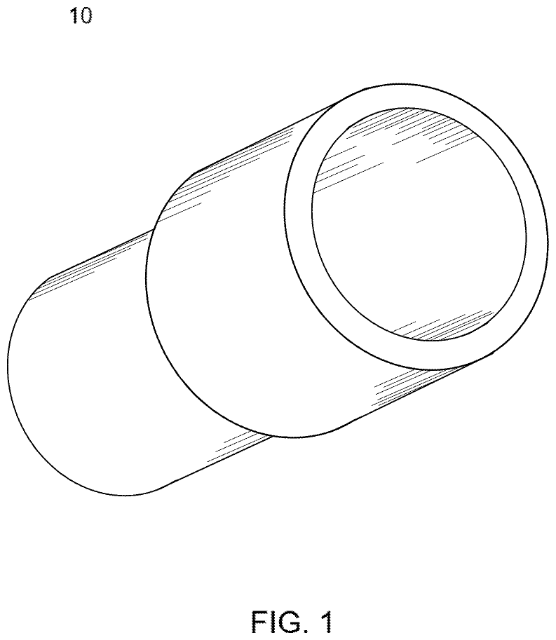

FIG. 1 illustrates a side view of the custom-fit grip, indicated by reference numeral 10, in its initial rolled-up state prior to the installation onto a baseball bat handle.

The grip 10, fabricated from a blend of ethylene vinyl acetate (EVA) and thermoplastic polyurethane (TPU), exhibits properties such as shock absorption, attenuation, and dissipation. It is particularly designed to be heated and molded for personalized impressions of a user's fingers and hand placement. The grip 10 is depicted in a cylindrical configuration, with its material prepared for the subsequent steps of heating and impression molding. The overall size of the grip 10 in this state is determined based on the intended user's hand size, with specific variants available to cater to both child and adult hand sizes.

The figure further illustrates the grip 10 as being devoid of any impressions or markings, representing its form prior to customization. This demonstrates the reusable nature of the grip 10, as its material allows for repeated heating, molding, and cooling cycles until the desired personalized grip pattern is achieved.

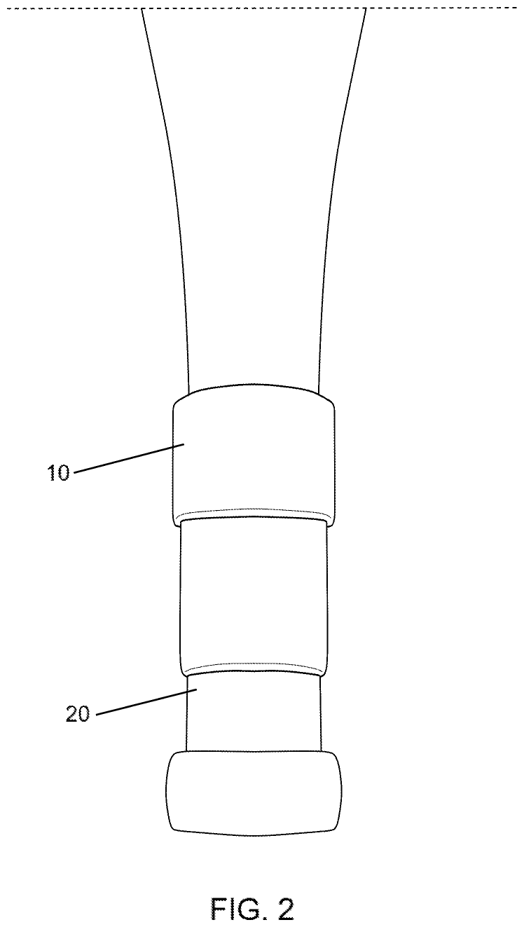

FIG. 2 shows a side view of the custom-fit grip, indicated by reference numeral 10, at an intermediate stage of installation onto a baseball bat handle, designated by reference numeral 20.

In this figure, the grip 10, initially a rolled-up cylinder, has been partially unrolled and mounted onto the handle 20. The grip 10 is being installed by progressively rolling it up along the length of the handle 20.

At this stage, the grip 10 is still warm from the heating process that softened the EVA and TPU blend, enabling it to conform to the contours of the handle 20 and be further prepared for the impression molding process. This also allows for any excess material to be trimmed off if necessary, to match the length of the handle 20.

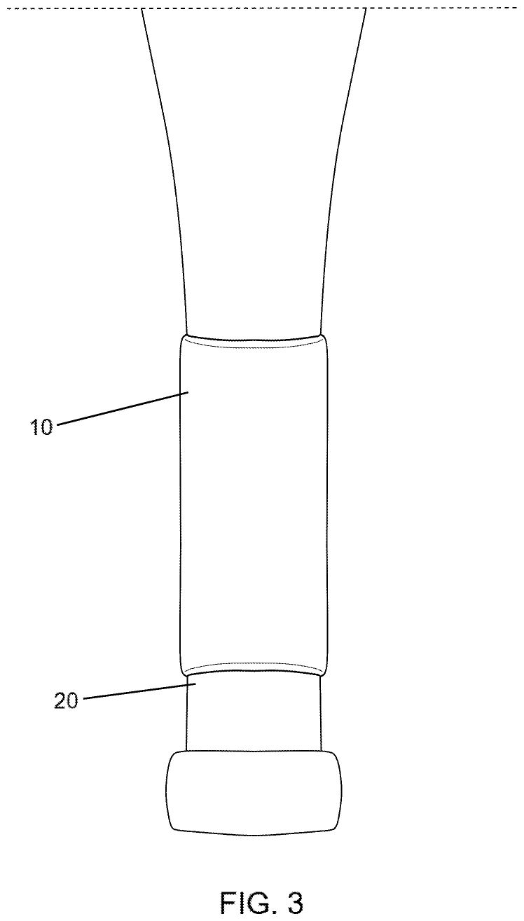

FIG. 3 illustrates a side view of the custom-fit grip 10 completely unrolled and secured onto the baseball bat handle 20.

The grip 10, previously rolled halfway up the handle 20 as shown in FIG. 2, is now fully extended along the length of the handle 20. The unrolled grip 10 conforms to the handle's shape and is ready for the impression molding process.

At this point, any excess material that extends beyond the handle's bottom end, if present, can be cut or trimmed off to match the exact length of the handle 20, providing a streamlined fit.

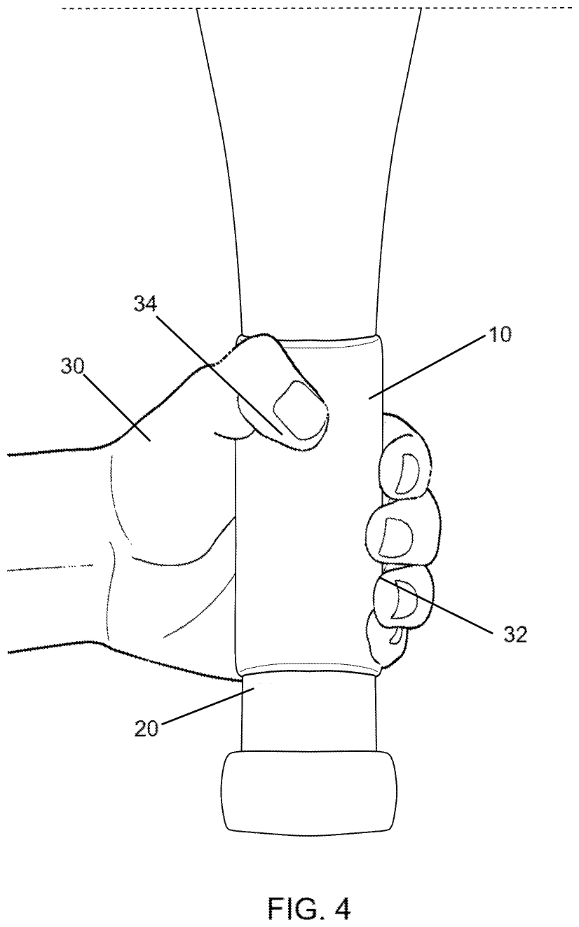

FIG. 4 shows the custom-fit grip 10 completely unrolled and attached to the baseball bat handle 20, now under the process of impression formation with a model hand 30.

The grip 10, fully extended along the handle 20 as depicted in FIG. 3, is now shown being impressed upon by the model hand 30. The hand model 30 is pressed into the malleable, warm grip 10, creating indentations at the points of contact. The model hand 30 is representative of a user's actual hand, and the placement of the fingers, thumb, and palm onto the grip 10 aids in creating accurate and precise hand position impressions.

The finger 32 and thumb 34 impressions in the grip 10 are specifically highlighted, demonstrating how the model hand 30 is used to create a distinct guide for the user's grip. The impressions left in the grip 10 from the model hand 30 are intended to act as a guide for the user, showing the correct hand positioning for holding and swinging the bat.

After the model hand 30 is removed, the impressions remain, creating a user-specific guide on the grip 10, enhancing the user's control and accuracy during swings. This personalized approach to training aids in the sport, provides a unique learning and performing advantage for users of all skill levels.

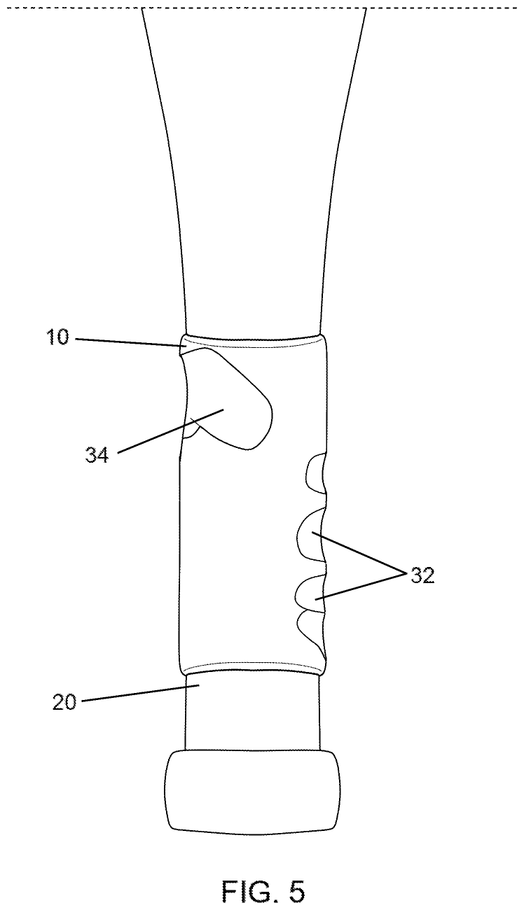

FIG. 5 shows the custom-fit grip 10 completely unrolled and attached to the baseball bat handle 20, with the model hand 30 removed, revealing the guide impressions left on the grip 10.

Upon the removal of the model hand 30, the resulting indentations in the grip 10 form a unique guide for the hand positioning of the user. The finger impressions 32 and thumb impression 34 are clearly visible, providing tactile guidance for the user's grip. These impressions 32, 34 provide a direct indication of the correct placement of the user's hand on the bat handle 20, aiding in mastering the correct grip and swing technique.

Moreover, the grip 10, with its thermoplastic polymer blend, maintains its capacity to absorb, attenuate, and dissipate shock forces, reducing the risk of wrist and elbow strain or injuries. This custom-fit grip 10 not only aids in the correct placement of the hand but also ensures a safer and more effective use of the baseball bat.

Unless otherwise defined, all terms (including technical terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

The disclosed embodiments are illustrative, not restrictive. While specific configurations of the training aid and method of manufacture have been described in a specific manner referring to the illustrated embodiments, it is understood that the present invention can be applied to a wide variety of solutions which fit within the scope and spirit of the claims. There are many alternative ways of implementing the invention.

It is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A customizable grip for a sports equipment handle, comprising: a blend of ethylene vinyl acetate (EVA) and thermoplastic polyurethane (TPU) molded to form a rollable sheet configured to wrap around the handle of a sports bat, the blend being impressionable, when heated to a temperature above 100 degrees Celsius, to accommodate a user's thumb and fingerprints and provide a personalized grip guide.

2. The customizable grip of claim 1, wherein the blend consists of 60% EVA and 40% TPU.

3. The customizable grip of claim 1, wherein the blend sets to form permanent impressions when cooled down from the temperature above 100 degrees Celsius.

4. The customizable grip of claim 1, wherein the sheet has a thickness of approximately 8.5 mm.

5. The customizable grip of claim 1, wherein the blend has a weight distribution ratio of between 5 to 50 percent by weight of TPU and between 95 to 40 percent by weight of EVA.

6. The customizable grip of claim 1, wherein the blend further comprises 5 to 15 percent by weight of a sodium or zinc ionomer.

7. The customizable grip of claim 1, wherein the grip is pre-sized to fit generic child or adult hand sizes.

8. The customizable grip of claim 1, wherein the child version is generally in the range of 15 to 25 percent smaller than the adult size.

9. A method of manufacturing a customizable grip for sports equipment handles, the method comprising:
heating a sheet comprising a blend of EVA and TPU to a temperature exceeding 100 degrees Celsius;
rolling the heated sheet onto a sports equipment handle;
applying pressure to the heated sheet to form impressions of an intended user's thumb and fingerprints; and
cooling the sheet under cold water to permanently set the impressions.

10. The method of claim 9, wherein the blend consists of 60% EVA and 40% TPU.

11. The method of claim 9, further comprising resetting the impressions by reheating the grip, allowing for the grip to return to its original shape and new impressions to be made.

12. The method of claim 10, further comprising repeating the steps of heating, impressing, and cooling until the impressions are deemed correct.

13. The method of claim 9, wherein the cooling step comprises running the grip under cold water for about 30 seconds.

14. The method of claim 9, further comprising cutting off excess plastic from the bottom of the bat after fitting the grip.

15. The method of claim 9, further comprising using a model hand to leave the guide impressions on the grip.
